(19) United States
(12) Patent Application Publication
(10) Pub. No.: US 2026/0082188 A1
(43) Pub. Date: Mar. 19, 2026

(54) DYNAMICALLY ADJUSTABLE MAP DATA FOR ADAS/AD FEATURES

(71) Applicant: QUALCOMM Incorporated, San Diego, CA (US)

(72) Inventors: Michael Wolfgang BACHMANN, Augsburg (DE); Joao Miguel GUERRA TOSCANO BRAVO, Haar (DE); Florian Christian BREINTNER, Schönberg (DE)

(21) Appl. No.: 18/890,500

(22) Filed: Sep. 19, 2024

(51) Int. Cl. H04W 4/40; H04W 4/38; H04W 64/00

(52) U.S. Cl. CPC H04W 4/40; H04W 4/38; H04W 64/00

(57) ABSTRACT

Aspects presented herein may enable a user equipment (UE) to dynamically adjust map data to be downloaded from a server based on currently available information and the specifications/demands of advanced driver assistance systems (ADAS) and/or autonomous driving (AD) features, thereby reducing/optimizing the overall map data transferred over-the-air. In one aspect, a UE identifies whether at least one vehicle feature meets a set of thresholds based on at least one of stored map data, sensor information, or vehicle-to-everything (V2X) information. The UE transmits, to a server based on an identification of whether the at least one vehicle feature meets the set of thresholds, a request for map data. The UE receives, from the server based on the request, the requested map data.

### TECHNICAL FIELD

The present disclosure relates generally to assisted/autonomous driving, and more particularly, to advanced driver assistance systems (ADAS) and/or autonomous driving (AD) features using map data.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus identifies whether at least one vehicle feature meets a set of thresholds based on at least one of stored map data, sensor information, or vehicle-to-everything (V2X) information. The apparatus transmits, to a server based on an identification of whether the at least one vehicle feature meets the set of thresholds, a request for map data. The apparatus receives, from the server based on the request, the requested map data.

In an aspect of the disclosure, a method, a computer-readable medium, and an apparatus are provided. The apparatus receives, from a user equipment (UE), an indication of a set of thresholds for at least one vehicle feature or an amount of map data specified for the at least one vehicle feature to meet the set of thresholds. The apparatus transmits, to the UE based on the indication via the at least one network interface, additional map data or reduced map data.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a vehicle performing road object detection using different types of sensors in accordance with various aspects of the present disclosure.

FIG. 5 is a diagram illustrating an example of a vehicle performing map over the air in accordance with various aspects of the present disclosure.

FIG. 6A is a diagram illustrating an example of a clear/perfect view condition that enables an advanced driver assistance systems (ADAS)/autonomous driving (AD) system of a vehicle to detect road and traffic signs without map data in accordance with various aspects of the present disclosure.

FIG. 6B is a diagram illustrating an example of a reduced view condition where an ADAS/AD system of a vehicle may not be able to detect road and traffic signs and is specified to use/rely map data in accordance with various aspects of the present disclosure.

FIG. 7A is a diagram illustrating an example of a vehicle obtaining road and traffic information based on car to car (C2C)/vehicle to everything (V2X) communication under a reduced view condition in accordance with various aspects of the present disclosure.

FIG. 7B is a diagram illustrating an example of a vehicle being able to perceive its environment correctly under a reduced view condition based on map data but may not be able to detect traffic light status in accordance with various aspects of the present disclosure.

FIG. 8 is a diagram illustrating an example of a map data communication between a UE and a server in accordance with various aspects of the present disclosure.

FIG. 9 is a diagram illustrating an example of a map data communication between a UE and a server in accordance with various aspects of the present disclosure.

FIG. 10 is a flowchart of a method of wireless communication.

FIG. 11 is a flowchart of a method of wireless communication.

FIG. 12 is a diagram illustrating an example of a hardware implementation for an example apparatus and/or network entity.

FIG. 13 is a flowchart of a method of wireless communication.

FIG. 14 is a diagram illustrating an example of a hardware implementation for an example network entity.

### DETAILED DESCRIPTION

Aspects presented herein may improve the overall performance and functionality for certain advanced driver assistance systems (ADAS)/autonomous driving (AD) features by enabling these ADAS/AD features to dynamically adjust map data specified while ensuring that the ADAS/AD features are functional or able to achieve a functional quality that exceeds a defined quality threshold. Aspects presented herein may also reduce the network traffic by optimizing/minimizing the amount of map data that is transmitted over the air. In one aspect of the present disclosure, a user equipment (UE) (which may be used to refer to a vehicle, a vehicle UE, an ADAS/AD system of a vehicle, an electronic control unit (ECU) of the vehicle, and/or an on-board unit (OBU) of the vehicle, etc., collectively) may be configured to dynamically adjust the amount of map data for downloading based on its ADAS/AD feature needs/demands. For example, in some scenarios, an ADAS/AD feature may function properly (or above a defined function threshold) with just a subset of map data or without map data in specific situations. However, in some scenarios, the ADAS/AD feature may specify additional/more map data to handle a special situation (e.g., in a heavily degraded environment). By enabling the UE to dynamically adjust the received map data based on the current situation and ADAS/AD feature specifications instead of configuring the UE to (always) request all available map data, the overall map data transferred over the air may be reduced and optimized. For example, the UE may aggregate map, sensor, and car to car (C2C)/vehicle to everything (V2X) data to determine which map data is specified to subscribed/unsubscribed (e.g., to download or to skip download) to ensure ADAS/AD feature performance. Then, ADAS/AD feature(s) may detect in advance if additional map data is needed to prevent reduced working mode or degradation and dynamically request for additional map data.

Aspects presented herein are directed to techniques/protocols for dynamic map data configuration and optimization based on current conditions and/or ADAS/AD features that require map data (e.g., HD map data). Aspects presented herein may contain the following aspects/features: (1) dynamic configuration of map data download/usage based on current environment, operating conditions and/or required services/operations (e.g., ADAS/AD features that are required); (2) prediction of map data needed for proactive download based on information related to upcoming events (e.g., traffic conditions, routes, weather conditions, etc.); and (3) aggregation of data from different sources (e.g., map data, V2X data, camera data, etc.) to optimize map data required for current and future situations.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit.

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

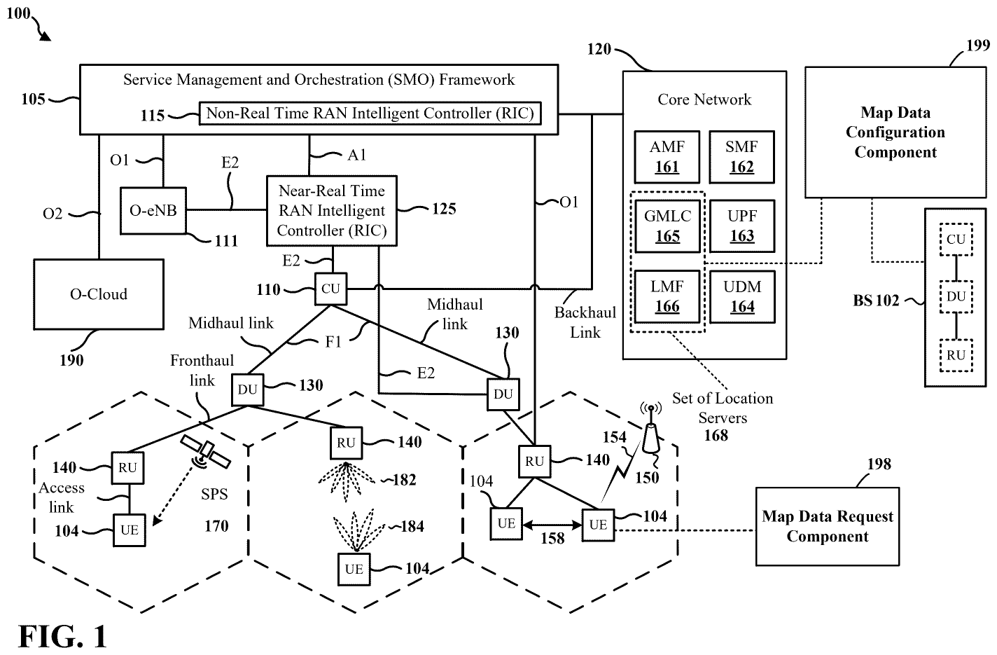

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FRI is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a map data request component 198 that may be configured to identify whether at least one vehicle feature meets a set of thresholds based on at least one of stored map data, sensor information, or vehicle-to-everything (V2X) information; transmit, to a server based on an identification of whether the at least one vehicle feature meets the set of thresholds, a request for map data; and receive, from the server based on the request, the requested map data. In certain aspects, the base station 102 or the one or more location servers 168 may have a map data configuration component 199 that may be configured to provide map data to the UE 104. For example, the map data configuration component 199 may be configured to receive, from a UE, an indication of a set of thresholds for at least one vehicle feature or an amount of map data specified for the at least one vehicle feature to meet the set of thresholds; and transmit, to the UE based on the indication, additional map data or reduced map data.

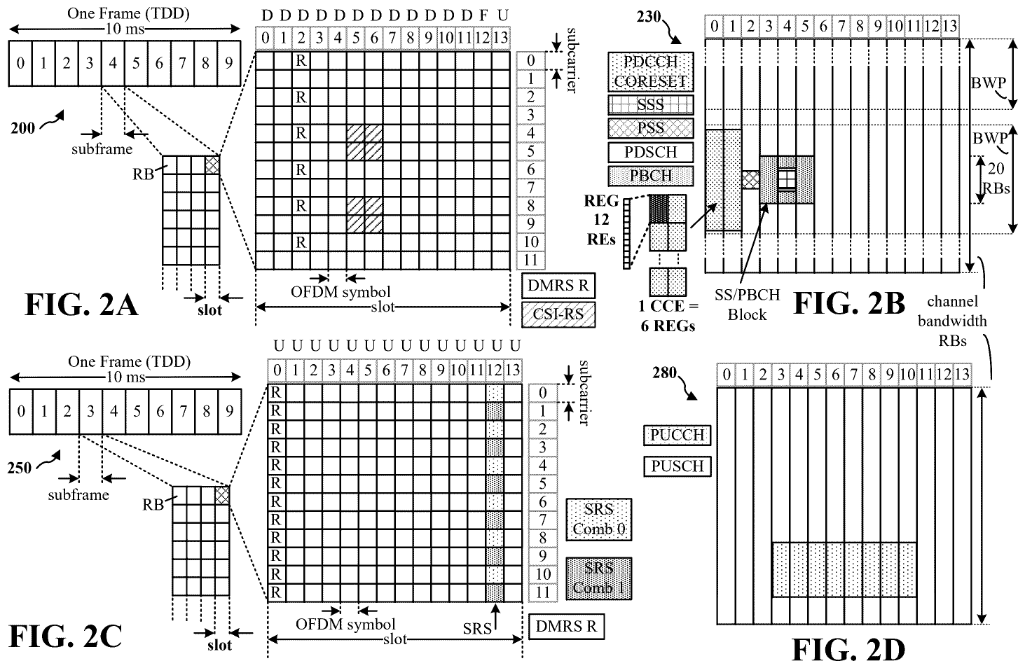

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

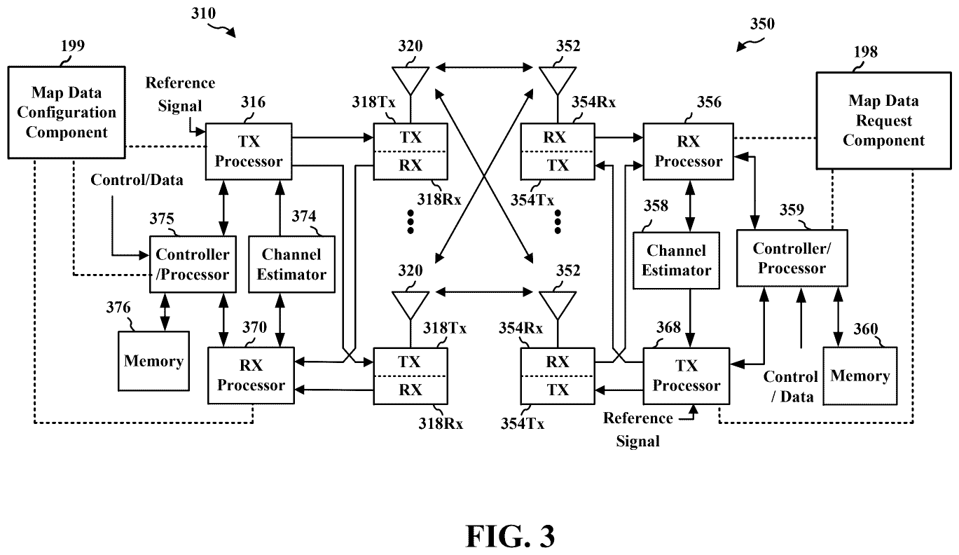

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the map data request component 198 of FIG. 1.

At least one of the TX processor 316, the RX processor 370, and the controller/processor 375 may be configured to perform aspects in connection with the map data configuration component 199 of FIG. 1.

In recent years, vehicle manufacturers have been developing vehicles with assisted driving and/or autonomous driving capabilities. Assisted driving, which may also be called advanced driver assistance systems (ADAS), may refer to a set of technologies designed to enhance vehicle safety and improve the driving experience by providing assistance and automation to the driver. These technologies may use various sensor(s), such as camera(s), radar(s), light detection and ranging (lidar(s) or lidar sensor(s)), etc., and other components to monitor a vehicle's surroundings and assist the driver of the vehicle with certain driving tasks. For example, some features of assisted driving systems may include: (1) adaptive cruise control (ACC) (e.g., a system that automatically adjusts a vehicle's speed to maintain a safe following distance from the vehicle ahead), (2) lane-keeping assist (LKA) (e.g., a system that uses cameras to detect lane markings and helps keep the vehicle centered within the lane, and provides steering inputs to prevent unintentional lane departure), (3), autonomous emergency braking (AEB) (e.g., a system that detects potential collisions with obstacles or pedestrians and automatically apply the brakes to avoid or mitigate the impact), (4) blind spot monitoring (BSM) (e.g., a system that uses sensors to detect vehicles in a driver's blind spots and provides visual or audible alerts to avoid potential collisions during lane changes), (5) parking assistance (e.g., a system that assists drivers in parking their vehicles by using camera(s) and sensor(s) to help with parallel parking or maneuvering into tight spaces), and/or traffic sign recognition (e.g., camera(s) and image processing are used to recognize and display traffic signs such as speed limits, stop signs, and other road regulations on the vehicle's dashboard).

Autonomous driving (AD), which may also be referred to as the autonomous driving system (ADS), self-driving, and/or driverless technology, may refer to the ability of a vehicle to navigate and operate itself without specifying human intervention (e.g., travelling from one place to another place without a human controlling the vehicle). The goal of the autonomous driving is to create vehicles that are capable of perceiving their surroundings, making decisions, and controlling their movements, all without the direct involvement of a human driver. To achieve or improve the autonomous driving, a vehicle may be specified to use a map (or map data) with detailed information, such as a high-definition (HD) map. An HD map may refer to a highly detailed and accurate digital map designed for use in autonomous driving and ADAS. In one example, HD maps may typically include one or more of: (1) geometric information (e.g., precise road geometry, including lane boundaries, curvature, slopes, and detailed 3D models of the surrounding environment), (2) lane-level information (e.g., information about individual lanes on the road, such as lane width, lane type (e.g., driving, turning, or parking lanes), and lane connectivity), (3) road attributes (e.g., data on road features like traffic signs, signals, traffic lights, speed limits, and road markings), (4) topology (e.g., information about the relationships between different roads, intersections, and connectivity patterns), (5) static objects (e.g., locations and details of fixed objects along the road, such as buildings, traffic barriers, and poles), (6) dynamic objects (e.g., real-time or frequently updated data about moving objects, like other vehicles, pedestrians, and cyclists), and/or (7) localization and positioning: precise reference points and landmarks that help in accurate vehicle localization on the map, etc.

Note while some assisted/autonomous driving systems may demand the use of HD map data, there are also assisted/autonomous driving systems and information systems that may be configured not to use HD map data (e.g., due to costs). For example, the Society of Automotive Engineers (SAE) has defined six levels of driving automation, from Level 0 (no automation) to Level 5 (full automation). For Level 0 (no automation), the human driver may be responsible for all aspects of driving, and the system may provide warnings or momentary assistance but does not take control of the vehicle. Example features for SAE Level 0 may include automatic emergency braking, blind spot warnings, and lane departure warnings, etc. As such, SAE Level 0 may not specify using HD map data. For Level 1 (driver assistance), the vehicle may assist with either steering or acceleration/deceleration (but may not perform both simultaneously). The human driver is still responsible for most driving tasks and must be ready to take over at any time. Example features for SAE Level 1 may include adaptive cruise control or lane-keeping assistance (e.g. lane centering), etc. For Level 2 (partial automation), the vehicle may control both steering and acceleration/deceleration under certain conditions, but the human driver is requested to remain engaged and monitor the driving environment at all times. Example features for SAE Level 2 may include ADAS, adaptive cruise control and lane-keeping assistance at the same time, etc. For Level 3 (conditional automation), the vehicle may perform all driving tasks under specific conditions, and the human driver may not be specified to monitor the environment but must be ready to take over when requested by the system. Example features for SAE Level 3 may include traffic jam chauffeur, where the vehicle is capable of handling driving in traffic jams without driver intervention. For Level 4 (high automation), the vehicle is capable of handling all driving tasks within certain conditions or environments (geofenced areas). The system may operate without human intervention but may specify a human driver outside its operational domain. Example features for SAE Level 4 may include local driverless taxi and pedals/steering, etc. For Level 5 (full automation), the vehicle is capable of performing all driving tasks under all conditions, and does not specify the human driver at any time. Example features for SAE Level 5 may include fully autonomous vehicles with no steering wheel or pedals. In summary, SAE Level 0 may be defined as features to provide warnings and assistance. ADAS is usually SAE Level 1 and 2, while AD is considered SAE level 3 to 5. Aspects presented herein (described below) may apply to all levels of SAE, including SAE Level 0 (e.g., for speed warning). For purposes of the present disclosure, a system or information system that is used in associated with SAE Level 0 to Level 5 may collectively be referred to as a “vehicle system,” which may encompass the assisted driving and the autonomous driving.

To enable a vehicle to be capable of providing assisted driving and/or autonomous driving, the vehicle may be configured to use various machine learning (ML) and/or neural network (NN) frameworks. An ML/NN framework may refer to a set of tools, libraries, and/or software components that are configured to provide a structured way to design, build, and deploy ML/NN models and applications. These frameworks may be able to simplify the process of developing ML/NN algorithms and applications by providing a foundation of pre-built functions, algorithms, and utilities. They may typically include features for data preprocessing, model training, evaluation, and/or deployment, etc. ML/NN frameworks may come in various programming languages, and they may be configured to cater to different types of machine learning tasks, including supervised learning, unsupervised learning, and/or reinforcement learning, etc. An ML/NN model may refer to a mathematical representation of a real-world process or problem, created using ML/NN algorithms and techniques. These ML/NN models may be configured to make predictions, classify data, and/or solve specific tasks based on patterns and relationships learned from input data. A deep learning framework may refer to a specialized software library or toolset that provides specified components and abstractions for building, training, and deploying deep neural networks. Deep learning frameworks may be designed to facilitate the development of complex neural network models, especially deep neural networks with multiple layers. These frameworks may offer a wide range of pre-implemented layers, optimizers, loss functions, and other components, making it easier for researchers and developers to work with deep learning models.

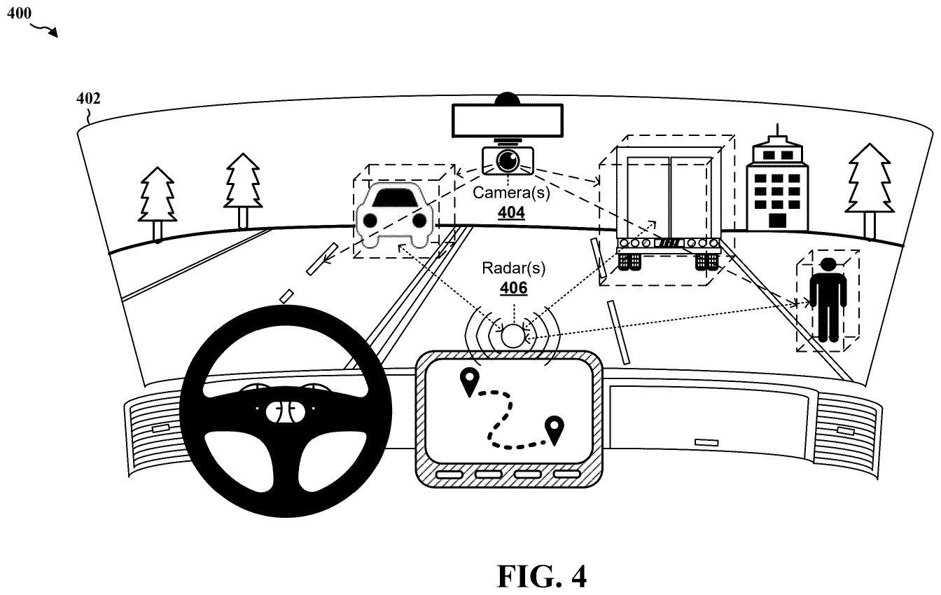

FIG. 4 is a diagram 400 illustrating an example of a vehicle performing road object detection using different types of sensors in accordance with various aspects of the present disclosure. In some implementations, a vehicle system may be configured to perform road object detections using multiple types of sensors (and also one or more ML/NN models). For purposes of the present disclosure, a road object or a traffic participant may refer to an object that is related to roads and driving, and is typically/commonly used/considered by the vehicle system in providing assisted driving or performing autonomous driving. In some examples, the road object/traffic participant may also be referred to as a traffic-related object. For example, a road object/traffic participant may be another vehicle, a pedestrian, a cyclist/bicycle, an animal, a traffic cone, a traffic sign, a traffic light, traffic, a traffic lane, a traffic line, a vulnerable road user (VRU), an object that is within a threshold distance of the vehicle, and/or any objects that may typically present on the roads (e.g., on the driving paths of vehicles), etc. On the other hand, a non-road object or a non-traffic participant (which may also be referred to as a non-traffic related object) may refer to an object that is not related to roads and driving, and is typically/commonly not used/considered by the vehicle system in providing assisted driving or performing autonomous driving. For example, a non-road object/non-traffic participant may be an object that is not within a threshold distance of the vehicle (e.g., a house on the side of the road, a mountain that is far away), an object that is not typically presented on a driving path/road (an airplane, a fire hydrant, a tree, etc.), a structure that is typically not traversed by vehicles (e.g., a pedestrian bridge), etc. An ML/NN model may be trained to identify whether an object is a road object or a non-road object.

For example, as shown by the diagram 400, a vehicle or a vehicle system (collectively as a “UE 402”) may be configured to use different types of sensors, such as a set of cameras 404 and/or a set of radars 406 for detecting road objects. For purposes of the present disclosure, the term “radar” may broadly refer to a device/component that is capable of detecting at least the presence and/or the distance of a physical object. Examples of radar may include an RF radar, a sonar, an ultrasonic sensor, a light detection and ranging (lidar), etc. In some implementations, the UE 402 may also use different MN/NN models for identifying different types of road objects. For example, a first ML/NN model may be trained/used to detect and track polylines from sensor output(s) (e.g., images captured by the camera(s) of the vehicle, point clouds generated from radar(s)/lidar(s), etc.), while a second ML/NN model may be trained/used to detect and track objects in a three-dimensional (3D) space (e.g., to perform 3D object detection (3DOD) tasks). Then, the outputs of different types of sensors (e.g., from the set of cameras 404 and the set of radars 406) may be processed and used by the ADAS or the autonomous driving system (e.g., for assisted/autonomous driving). A point cloud may refer to a discrete set of data points in space, where these points may represent a 3D shape or object. In some implementations, each point position may be associated with a set of Cartesian coordinates (X, Y, Z). Point clouds may be produced by radar(s)/lidar(s) by detecting multiple points on the external surfaces of objects.

As described in connection with FIG. 4, various applications (e.g., use cases) such as assisted driving and/or autonomous driving, may specify the use of map data. To keep the map data up-to-date, these applications (or devices running these applications) may be configured to download updated map data from a server from time to time or based on certain pre-defined conditions (e.g., when travelling to an area that is without map data). In some implementations, downloading map data from a server may be referred to as “map over the air” (MOTA).

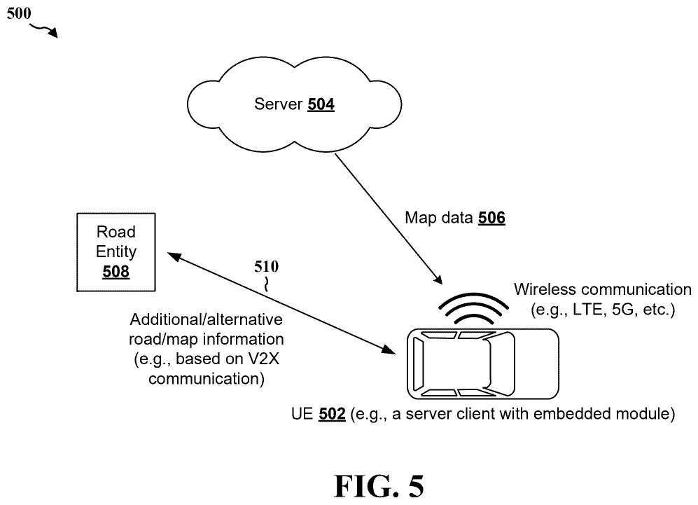

FIG. 5 is a diagram 500 illustrating an example of a vehicle performing map over the air in accordance with various aspects of the present disclosure. In one example, map over the air may refer to a process of a server 504 sending (real-time) map data 506 to a UE 502 (e.g., a vehicle, a vehicle system, an on-board unit (OBU) of the vehicle, a device running a navigation application, etc.) over a wireless network/communication (e.g., an LTE network, a 5G network, etc.), enabling the UE 502 to make decisions based on the latest information about the road and traffic conditions. Depending on implementations and conditions, different amount of map data 506 may be downloaded by the UE 502 from the server 504. For example, in some scenarios, the UE 502 may be configured to (1) download map data before driving, (2) download just updates for road conditions (e.g. traffic jams, construction work, etc.) while driving, (3) continuously download updated map data whenever available, or (4) a combination thereof, e.g., the UE 502 may download map data before driving, and continuously to download the updates while driving, including changes in map data (e.g. newly opened or closed street/highway, short term construction work). In some scenarios, the UE 502 may also be configured to stream the map data 506, which means the UE 502 does not download the map data before driving (e.g., the map data is streamed in real-time while the UE 502 is driving).

In a typical implementation, the map data 506 is transmitted from the server 504 (e.g., a cloud-based system), where the server 504 may utilize sensors and other data sources to collect and analyze information about the road network and traffic patterns. For example, the server 504 may receive and gather traffic/road information provided by a group of UEs (e.g., vehicles, roadside units (RSUs), etc.). In some examples, the information/data collected by a server from multiple UEs may be referred to as “fleet data” or “crowdsourced/crowdsourcing data.” This data may be processed and combined with other data, such as GPS/GNSS and/or camera data from multiple users (e.g., from other UEs/vehicles and/or the UE 502) to create a detailed map of the environment in real-time. Then, an application (e.g., for autonomous driving, navigation, positioning, etc.) of the UE 502 may access the map data 506 over a wireless network (e.g., a cellular or satellite network), and use the map data 506 to make decisions about speed, route, and other factors, etc. For example, the UE 502 may use the map data 506 to avoid road construction, traffic congestion, or accidents, and to optimize its route for efficiency and safety, etc. In some examples, as shown at 510, the UE 502 may also be configured to receive (additional) road/map information from another road entity 508, such as from another vehicle/UE, a roadside unit (RSU), or a traffic/road infrastructure (e.g., traffic lights), such as based on vehicle-to-everything (V2X) communication protocol/technology. For purposes of the present disclosure, an RSU, a traffic/road infrastructure may also be referred to as a UE.

Map data with lane-level information, such as road maps with lane-level connectivity, may play a crucial role in enhancing the safety, the efficiency, and/or the overall performance of autonomous driving systems and ADAS systems, and may also contribute to the realization of a safer and more connected transportation future. For purposes of the present disclosure, a map data with lane-level information and/or connectivity may be referred to as a “lane-map,” a “lane-level map,” “lane-map data,” and/or “lane-level map data,” etc., which may indicate that the map data includes information related to different lanes of a road. In addition, depending on the context, the term “map data” may be used interchangeably with the term “map.”

Over the last few years, AI/ML technologies used in association with camera systems (e.g., for object detections and/or identifications, etc.) have improved significantly, which may enable some advanced driver assistance systems (ADAS) and/or autonomous driving (AD) features/functionalities (collectively as “ADAS/AD feature(s)” hereafter), such as SAE Level 2 and upward driving capabilities, to be able to operate/work with minimum (HD) map data or even without (HD) map data in certain/good environments. Thus, less map data may be specified for or demanded by certain (basic) ADAS/AD features. In typical scenarios, the amount of map data specified by an ADAS/AD feature (to operate or to achieve minimum functionality) may be calculated based on the location and/or direction of a vehicle.

However, as camera systems and their associated AI/ML technologies may be susceptible to environmental conditions, (HD) map data may enable certain ADAS/AD feature(s) to function properly in non-optimal situations or environmental conditions (e.g., traffic jams, fogs, rains, sunsets, and others, etc.), and may often be used in difficult situations (e.g., emergency situations, GNSS degraded situations, etc.). As such, manufactures (e.g., original equipment manufacturers (OEMs) for vehicles, ADAS/AD system vendors, etc.) may still want to use (HD) map data to improve the overall ADAS/AD feature quality while also try to limit the usage/reliance of the (HD) map data at the same time to reduce communication resources/overheads and costs. In addition, as car to car (C2C) and vehicle to everything (V2X) communication are likely to increase over time and provide more useable information, certain information provided by map data may be replaced by or obtained from V2X communication instead. Note in some examples, the C2C communication may be part of the V2X communication (e.g., V2X communication may comprise C2C communication).

In some scenarios, based on traffic situations and/or weather conditions, some ADAS/AD features/systems may specify HD map data instead of standard definition (SD) map data (e.g., may refer to non-HD map data) or no map data for better performance, such as when lane markings or traffic signs are obscured (e.g., unable to be observed with certain confidence levels). In another example, some ADAS/AD features may be deactivated or entered into a degraded working mode due to some triggering or environmental conditions, where less or no map data may be specified by these ADAS/AD features (e.g., just speed limit information may be sufficient). As such, some vehicle/ADAS/AD features (e.g., on demand features) may demand changes in received map data. In addition, the availability of V2X communication(s) may also reduce the amount of map data specified by some ADAS/AD features (e.g., obtain traffic light information provided by the traffic light directly or from other vehicle(s) in the vicinity instead of from map data).

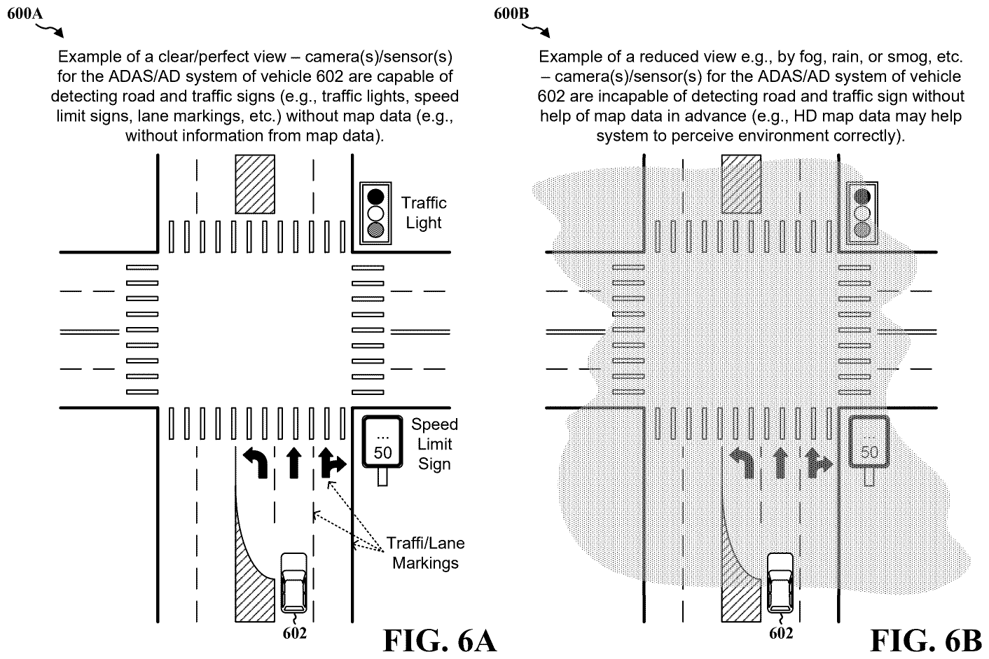

FIG. 6A is a diagram 600A illustrating an example of a clear/perfect view condition that enables an ADAS/AD system of a vehicle to detect road and traffic signs without map data in accordance with various aspects of the present disclosure. As shown by the diagram 600A, when the weather and/or lighting conditions are good/clear, camera(s)/sensor(s) for an ADAS/AD system of a vehicle 602 may be able to detect traffic signs, traffic light status (e.g., red, yellow, or green), and/or traffic/lane markings, etc. As such, some ADAS/AD features of the ADAS/AD system may not be specified to use or rely information from map data. In other words, these ADAS/AD features may be able to function properly (or above a specified quality/functionally threshold) without map data. Example of these ADAS/AD features may include traffic sign recognition, collision avoidance system, intelligent speed adaptation, etc.

FIG. 6B is a diagram 600B illustrating an example of a reduced view condition where an ADAS/AD system of a vehicle may not be able to detect road/traffic signs and is specified to use/rely map data in accordance with various aspects of the present disclosure. As shown by the diagram 600B, when the weather and/or lighting conditions are poor/reduced, camera(s)/sensor(s) for an ADAS/AD system of the vehicle 602 may be not be able to detect traffic signs, traffic light status, and/or traffic/lane markings (with a defined confidence level). As such, some ADAS/AD features of the ADAS/AD system may not function properly. However, in some scenarios, map data, such as HD map data, may be able to provide that information to the ADAS/AD system, such that the ADAS/AD system may still perceive the environment of the vehicle 602 correctly. For example, the map data may provide the traffic signs/markings for areas in proximity to the vehicle 602, such that ADAS/AD features such as traffic sign recognition or intelligent speed adaptation may still function properly without camera/sensor data (e.g., without using camera(s)/sensor(s)).

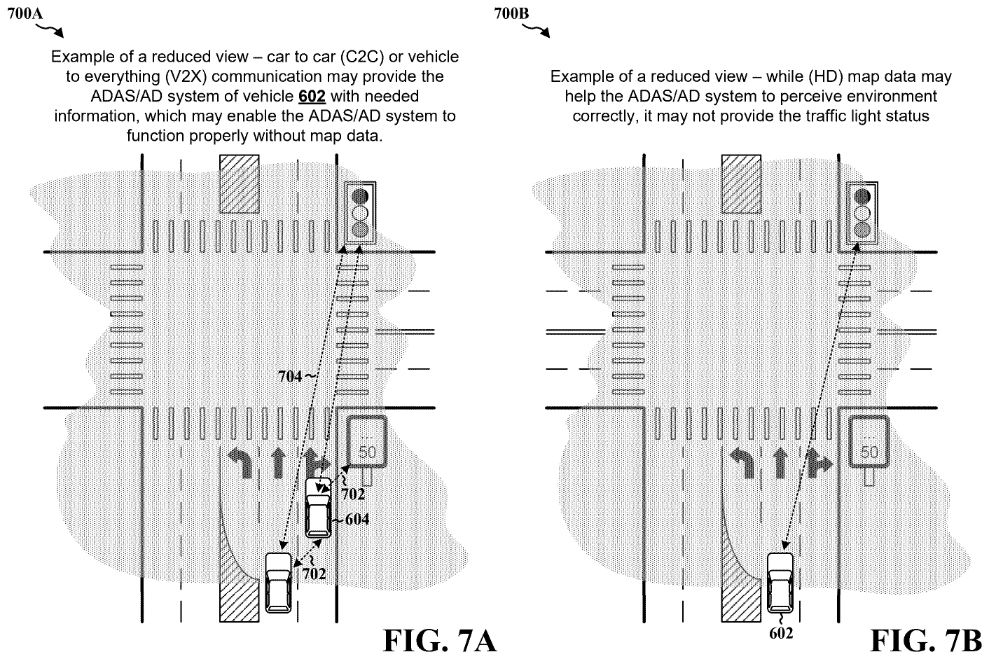

FIG. 7A is a diagram 700A illustrating an example of a vehicle obtaining road and traffic information based on V2X communication under a reduced view condition in accordance with various aspects of the present disclosure. In some scenarios, while a reduced view condition discussed in connection with FIG. 6B may not enable the ADAS/AD system of the vehicle 602 to detect traffic signs, traffic light status, and/or traffic/lane markings (with a defined confidence level), the ADAS/AD system of the vehicle 602 may be able to obtain that information based on V2X communication if available. For example, as shown at 702, a second vehicle 604 that is ahead of the vehicle 602 may be able to detect the traffic signs and/or the traffic light status that are ahead of the vehicle 602, and share this information with the vehicle 602 via a V2X communication. In another example, as shown at 704, certain traffic infrastructures, such as traffic lights, may have the capability to provide traffic information (e.g., traffic light status) directly to vehicles, such as via a V2X communication. As such, some ADAS/AD features of the ADAS/AD system may be able to function properly (or above a specified quality/functionally threshold) without both the clear view/perfect view and the map data.

FIG. 7B is a diagram 700B illustrating an example of a vehicle being able to perceive its environment correctly under a reduced view condition based on map data but may not be able to detect traffic light status in accordance with various aspects of the present disclosure. In some scenarios, while (HD) map data may help the ADAS/AD system of the vehicle 602 to obtain certain traffic information for the vehicle 602 and also to perceive the surrounding environment of the vehicle 602 under a reduced view condition, the HD map data may not be able to provide some live or changeable information, such as the traffic light status. As such, some ADAS/AD features may still not be able to function properly under a reduced view condition even with map data available.

While map data, such as HD map data, may be utilized by a vehicle for perceiving its environment in degraded/poor environmental conditions as discussed in connection FIGS. 6A, 6B, 7A, and 7B, map data may be expensive and specify a large amount of wireless resources to transmit and receive over the network. Thus, manufacturers and OEMs may have an inventive to minimize the transmission and the reception of map data between vehicles and a map data server (e.g., as discussed in connection with FIG. 5). Current/typical solutions related to downloading map data may focus on “freshness” of the map data, such as whether a vehicle is able to download specified map data in time, e.g., receiving traffic information related to an upcoming intersection prior to arriving the intersection. However, these solutions do not provide/enable dynamically adjusting map data based on the needs/demands of current available information and ADAS/AD features. As more ADAS/AD features are expected to be rolled out in vehicles worldwide, more map data is expected to be transferred and used. In addition, most configurations related to transmitting map data (e.g., from a server) and/or to receiving map data (e.g., at a vehicle) are static and not dynamically adjusted/adjustable. Thus, map data communicated between a vehicle and a server may not be based on actual ADAS/AD feature needs/demands. For example, as described in connection with FIGS. 6A and 7A, certain ADAS/AD features may be able to function without map data under certain conditions. On the other hand, as described in connection with FIGS. 6B and 7B, some ADAS/AD features/capabilities usually degrade when environmental conditions are considered not optimal. For example, level 3 autonomous driving capability on certain highways may be configured to be deactivated in case of heavy rain or heavy fog. Thus, sending additional map data may help preventing the degradation.

Aspects presented herein may improve the overall performance and functionality for certain ADAS/AD features by enabling these ADAS/AD features to dynamically adjust map data specified while ensuring that the ADAS/AD features are functional or able to achieve a functional quality that exceeds a defined quality threshold. Aspects presented herein may also reduce the network traffic by optimizing/minimizing the amount of map data that is transmitted over the air. In one aspect of the present disclosure, a user equipment (UE) (which may be used to refer to a vehicle, a vehicle UE, an ADAS/AD system of a vehicle, an electronic control unit (ECU) of the vehicle, and/or an OBU of the vehicle, etc., collectively) may be configured to dynamically adjust the amount of map data for downloading based on its ADAS/AD feature needs/demands. For example, in some scenarios, an ADAS/AD feature may function properly (or above a defined function threshold) with just a subset of map data or without map data in specific situations. However, in some scenarios, the ADAS/AD feature may specify additional/more map data to handle a special situation (e.g., in a heavily degraded environment). For purposes of the present disclosure and in the context of vehicle sensors, a heavily degraded environment may refer to an environment with one or more conditions that affect/degrade the performance or functionality of a sensor. For example, an environment with fog, pollution, or rain that reduces the visibility of a camera (below a visibility threshold) may be considered as a heavily degraded environment.

By enabling the UE to dynamically adjust the received map data based on the current situation and ADAS/AD feature specifications instead of configuring the UE to (always) request all available map data, the overall map data transferred over the air may be reduced and optimized. For example, the UE may aggregate map, sensor, and vehicle to everything (V2X) data to determine which map data is specified to subscribed/unsubscribed (e.g., to download or to skip download) to ensure ADAS/AD feature performance. Then, ADAS/AD feature(s) may detect in advance if additional map data is needed to prevent reduced working mode or degradation and dynamically request for additional map data. For purposes of the present disclosure, V2X may refer to a technology that enables vehicles to communicate with infrastructures, pedestrians and/or other vehicles. As such, V2X may broadly include car-to-car (C2C) communication, vehicle-to-vehicle (V2V) communication, and/or vehicle-to-infrastructure (V2I) communication, etc.

In another aspect of the present disclosure, a UE may be configured to operate with minimal map data by default. However, if the map data specified by the UE is not available through other resources, such as from camera(s), other sensor(s), and/or V2X communication(s), then the UE may be configured to request and download additional map data from a server (e.g., a map data server, a network, etc.). In other words, the UE may be configured to subscribe to additional map data to enable certain ADAS/AD features to continue their services/functions instead of degradation or not functioning, and also to unsubscribe unnecessary/additional map data if information from camera(s), sensor(s) and/or V2X communication(s) are sufficient (again) for the ADAS/AD features to continue their services/functions (with a defined quality/functioning threshold).

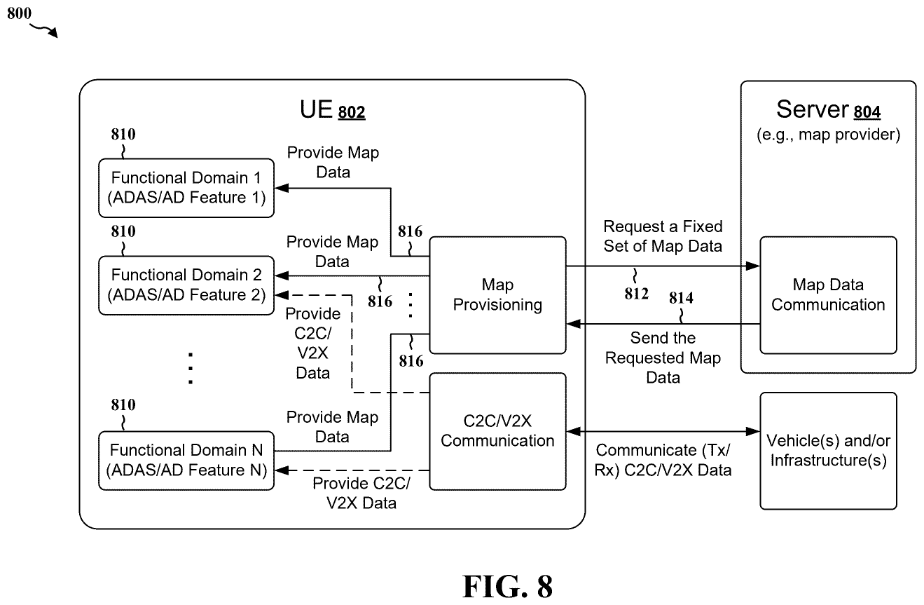

FIG. 8 is a diagram 800 illustrating an example of a map data communication between a UE and a server in accordance with various aspects of the present disclosure. In typical/current implementations, a UE may be configured to download/receive a fixed set/amount of map data when one or more ADAS/AD features specify map data. For example, as shown at 810, a UE 802 (which may be used to refer to a vehicle, a vehicle UE, an ADAS/AD system of a vehicle, an electronic control unit (ECU) of the vehicle, and/or an OBU of the vehicle, etc., collectively) may include a set of ADAS/AD features (which may also be referred to as “functional domain(s)”) that specify map data, such as traffic sign recognition, intelligent speed adaption, autonomous driving, etc.

As shown at 812, a map provisioning module of the UE 802 may be configured to send a map data request to a server 804 (e.g., a map data server, a network entity, etc.), such as to a map data communication module of the server 804 (e.g., a reception (Rx) module, a transceiver module, etc.) to request a fixed set/amount of map data. For example, the UE 802 may request the server 804 to provide map data for a specified area (e.g., an area in which the UE 802 is in or is expected to travel to). In response to the request, as shown at 814, the server 804 may transmit the requested map data to the UE 802 (e.g., via a transmission (Tx) module, the transceiver module, etc.). At 816, after obtaining the requested map data, the map provisioning module may distribute/transmit the map data to the set of ADAS/AD features based on their specifications/needs.

In some scenarios, as described in connection with FIGS. 6A, 6B, 7A, and 7B, such configuration/implementations may not be an effective/optimal way for managing map data resources, as the UE 802 may be configured to download map data when the set of ADAS/AD features is able to function properly (e.g., without degradation) without map data.

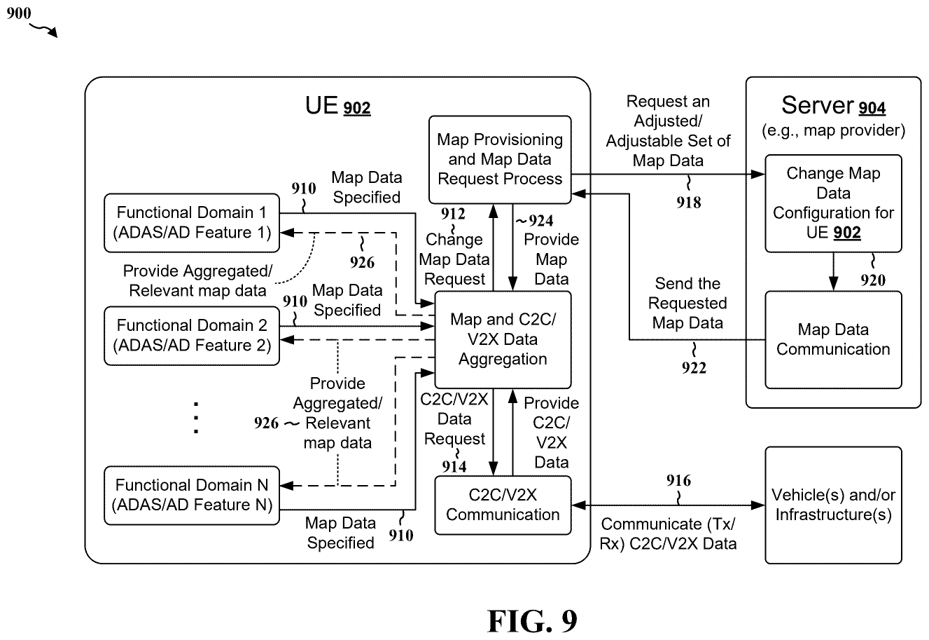

FIG. 9 is a diagram 900 illustrating an example of a map data communication between a UE and a server in accordance with various aspects of the present disclosure. In one aspect of the present disclosure, a UE 902 (which may be used to refer to a vehicle, a vehicle UE, an ADAS/AD system of a vehicle, an electronic control unit (ECU) of the vehicle, and/or an OBU of the vehicle, etc., collectively) may be configured to identify the amount of map data specified by a set of ADAS/AD features (e.g., at least one ADAS/AD feature). Depending on implementations, the amount of map data specified by an ADAS/AD feature (in the set of ADAS/AD features) may be based on an amount of map data that prevents the ADAS/AD feature from degradation or reduced performance (but the ADAS/AD feature may be operating at a minimum acceptable condition), or based on an amount of map data that enables the ADAS/AD feature to achieve a defined quality/functioning threshold (e.g., an accuracy above an accuracy threshold, a confidence level above a confidence level threshold, etc.).

For example, as shown 910, each ADAS/AD feature in a set of ADAS/AD features (e.g., ADAS/AD features that may use map data) may indicate to an aggregation module of the UE 902 (e.g., a map and V2X data aggregation module) an amount of map data it specified (e.g., to be functional or to achieve a defined quality/functioning threshold). For example, a first ADAS/AD feature may indicate it specifies an additional amount of map data (e.g., map data related to traffic light status), a second ADAS/AD feature may indicate it does not specify map data (currently or for a period of time), and an Nth ADAS/AD feature may indicate it specifies just traffic lane related information, etc.

Based on the map data specified by set of ADAS/AD features and also based on aggregating information from available (e.g., stored) map data, sensor information (including camera information), and/or V2X communication(s), the aggregation module (or the UE 902) may determine/identify whether the set of ADAS/AD features (or each ADAS/AD feature in the set of ADAS/AD features) is able to meet a defined quality/functioning threshold. In other words, the aggregation module may determine a (total) amount of map data specified by the set of ADAS/AD features, and identify whether the set of ADAS/AD features meets a set of thresholds based on the stored map data, sensor information, and/or V2X information. While not showing in the diagram 900, the UE 902 may obtain the sensor information from at least one sensor, such as described in connection with FIG. 4. The at least one sensor may include a camera, a radio frequency (RF) radar, a light detection and ranging (lidar) sensor), an ultrasonic sensor, or a combination thereof.

At 912, after identifying whether ADAS/AD features in the set of ADAS/AD features are capable of meeting their respective thresholds based on the stored map data, sensor information, and/or V2X information, the aggregation module may transmit a change map data request to a map provisioning and map data request process module (hereafter “map provisioning module”). A change map data request may be a request for an additional amount of map data (e.g., more map data compared to a current/default setting), or a request for a reduced amount of map data (e.g., less map data compared to a current/default setting).

For example, if the set of ADAS/AD features (e.g., all ADAS/AD features in the set of ADAS/AD features) is able to meet the set of thresholds (e.g., is able to function above the defined threshold) with just traffic light status information, the change map data request may request for a reduced amount of map data that just includes the traffic light status information (other information may be omitted for a period of time or until next request). On the other hand, if at least one ADAS/AD feature in the set of ADAS/AD features is unable to meet its corresponding threshold (e.g., is unable to function above the defined threshold) with currently available information, the change map data request may request for additional map data that enables the at least one ADAS/AD feature to meet its corresponding threshold. In some implementations, the speed of the vehicle and/or navigation information (e.g., the most probable path(s) to a destination) may also be considered in determining the amount of additional map data specified and/or in determining whether the at least one ADAS/AD feature to meet its corresponding threshold. For example, when a vehicle is moving at a high speed, a larger amount of additional map data may be specified or the threshold of the at least one ADAS/AD feature may be configured to be more stringent compared to the vehicle moving at a lower speed. In another example, the vehicle may be configured to prioritize map data related to paths that are likely to travel by the vehicle (e.g., based on the navigation information). As such, based on available information of upcoming events (e.g., traffic jam, route, weather conditions, speed of the vehicle, navigation information, etc.), the UE 902 may be capable of identifying an amount of map data specified in advance to prevent the set of ADAS/AD features from entering into a reduced or degraded working mode.

In some implementations, as shown at 914, the aggregation module may be configured to attempt retrieving specified information via V2X communication(s). For example, if at least one ADAS/AD feature is unable to function properly without the traffic sign and traffic light status information, the aggregation module (or the UE 902) may attempt to communicate with other vehicles and/or infrastructures in proximity to the UE 902 (e.g., via a V2X communication module) to obtain this information, such as shown at 916. If the aggregation module (or the UE 902) is able to obtain the specified information (or at least a portion of the specified information) via the V2X communication(s), the change map data request may exclude this information (e.g., the traffic sign and traffic light status information) or the portion of the information (e.g., just the traffic sign information or the traffic light status information) from the request.

At 918, based on the change map data request from the aggregation module (e.g., with an indication of specifying additional/reduced map data), the map provisioning module (or the UE 902) may transmit, to a server 904 (e.g., a map provider, a network entity, etc.), a request for an adjusted/adjustable set of map data. Note while the example in the diagram 900 illustrates that various functions are performed by various modules, it is merely for illustrative purposes. Depending on implementations, aspects described herein may also be performed by one module or the UE 902. For example, the map provisioning module, the aggregation module, and the V2X communication module may be one module.

At 920, based on the request for an adjusted/adjustable set of map data from the UE 902, the server 904 may change map data configuration(s) for the UE 902. Then, at 922, the server 904 may transmit the requested map data (e.g., the adjusted/adjustable set of map data) to the UE 902 (e.g., to the map provisioning module via a map data communication module).

At 924, the map provisioning module may transmit the requested map data to the aggregation module, and at 926, the aggregation module may provide an aggregated map data to the set of ADAS/AD features or provide just relevant map data to each ADAS/AD feature in the set of ADAS/AD features.

Depending on implementations, the aggregation module may be configured to check (or the set of ADAS/AD features may be configured to provide) the amount of map data specified (e.g., as described in connection with 910) periodically (e.g., every X minutes), upon request/on demand (e.g., when an ADAS/AD feature request additional/reduced map data), or based on triggering condition(s) (e.g., when there is a significant change in driving/environmental condition(s), etc.). For example, the UE 902 (or the aggregation module) may be configured to maintain a minimum amount of map data specified by the set of ADAS/AD features (e.g., as a default setting). Then, if the set of ADAS/AD features specifies information from additional map data (e.g., due to degraded weather/environmental conditions), the UE 902 (or the aggregation module) may request the server 904 to provide the additional map data, such as described in connection with 912 and 918. However, when the UE 902 is able to obtain the information without map data (e.g., the UE 902 is capable of obtaining the information via sensor(s) again as the weather/environmental conditions have improved), the aggregation module may (automatically) request the server 904 to revert the amount of map data provided back to the default setting (e.g., the UE 902 may be configured to maintain the minimum amount of map data again). As such, the UE 902 may dynamically determine the amount of map data it specified for enabling its ADAS/AD feature(s) to operate properly.

Aspects presented herein may reduce communication costs by intelligently aggregating specified map data and identifying which map data is specified and/or not needed from map in the current and upcoming situations. Based on this approach, an intelligent system can be built to reduce the overall amount of map data resources transmitted over-the-air while preventing ADAS/AD feature(s) from entering into a reduced or degraded mode. In some examples, the server 904 may be configured to store and update which map data is specified to send to which vehicle. While this may specify some overhead for the server implementation, most servers are already configured to check if a vehicle is allowed to receive map data, and which map data it should receive. Thus, the implementations may not have a significant impact to the server 904 as a similar configuration service may already be in place.

In another aspect of the present disclosure, or as an alternative implementation, the amount of map data specified by a set of ADAS/AD features of a vehicle (e.g., by the UE 902) may be determined by a server (e.g., the server 904) instead of the vehicle. For example, the UE 902 may transmit map data specified by the set of ADAS/AD features and/or a set of thresholds to be met by the set of ADAS/AD features, and the server 904 may determine whether current map data at the UE 902 (and/or previous map data transmitted to the UE 902) is sufficient for the set of ADAS/AD features to meet the set of thresholds. Then, the server 904 may transmit additional map data to the UE 902 if the current map data at the UE 902 is insufficient for the set of ADAS/AD features to meet the set of thresholds, or transmit reduced map data if the current map data at the UE 902 is sufficient for the set of ADAS/AD features to meet the set of thresholds (e.g., for a defined period).

In some scenarios, safety cases/studies for each ADAS/AD feature in the set of ADAS/AD features may define a set of minimum specifications for input data of the ADAS/AD feature (e.g., the confidence level/quality for images obtained by camera, the minimum amount of information specified by the ADAS/AD feature to function above an acceptable level, etc.). Then, based on those specifications and current active ADAS/AD features(s), the UE 902 may be able to derive a set of minimum datasets for object detections.

In some implementations, the aggregation module may be implemented at the UE 902 as a rule-based system, by an AI/ML approach, or a combination thereof. For example, for road/traffic marking identifications, the aggregation module may be configured to request for additional map data/reduced based on a defined rule, e.g., (camera confidence greater than 90%) OR ((camera confidence greater than 50%) AND ((map data provides lanes and curvature) OR (V2X communication provides upcoming road markings))). In another example, for stop signs, the aggregation module may be configured to request for additional/reduced map data using an AI/ML model, where the AI/ML model may request for additional/reduced map data based on whether a set of conditions is satisfied, e.g., (camera confidence greater than 90%) OR ((crossing and stop sign location present in map data) and (V2X communication detects a stop sign))

Based on the current active ADAS/AD features, the currently applicable rules may also be configured to be dynamically adjusted/adjustable. If an ADAS/AD feature (e.g., the change lane feature) is turned off/disabled, the specified input rules/specifications may be ignored until the feature is turned on/enabled again.

As aspects presented herein may enable the overall amount of map data transferred over-the-air to be reduced. As less communication data consumption due to reduced/adjusted map data may provide less cost to manufacturers and consumers, aspects presented herein may enable communication cost efficient “function-on-demand” ADAS/AD capabilities. Function-on-demand, which may also be referred to as features-on-demand (FoD) in some examples, may refer to the concept of remotely enabling, disabling, or upgrading a vehicle's functions/features (e.g., ADAS/AD capabilities) through over-the-air (OTA) updates after the vehicle has left the production line. In addition, aspects presented herein may improve feature performance with minimal possible extra data, where there may be a better feature key performance indicator (KPI) if additional map data is provided (depends on the ADAS/AD feature), degraded ADAS/AD capabilities may start working again when additional data is received, and/or there may be less reduced or degraded ADAS/AD capabilities, etc.

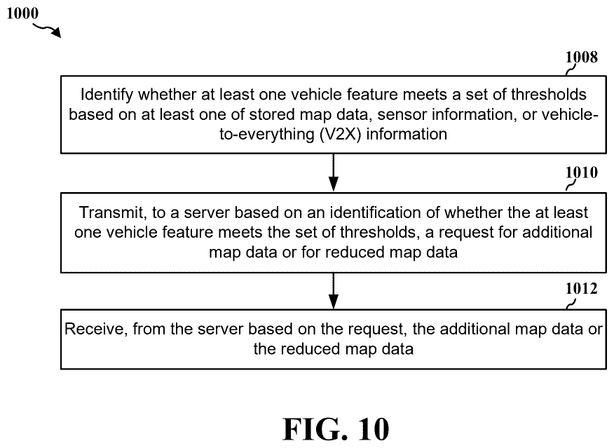

FIG. 10 is a flowchart 1000 of a method of wireless communication at a user equipment (UE). The method may be performed by a UE (e.g., the UE 104, 402, 502, 802, 902; the vehicle 602, 702; the apparatus 1204). The method may enable the UE to dynamically adjust map data to be downloaded from a server based on currently available information and the specifications/demands of ADAS/AD features, thereby reducing/optimizing the overall map data transferred over-the-air.

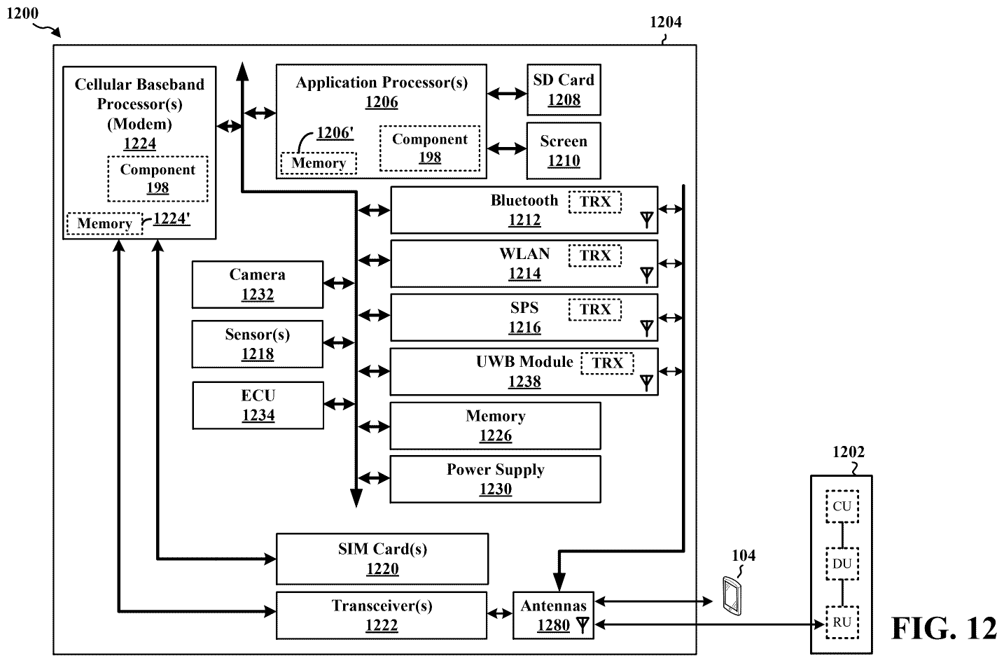

At 1008, the UE may identify whether at least one vehicle feature meets a set of thresholds based on at least one of stored map data, sensor information, or V2X information, such as described in connection with FIG. 9. For example, at 910, each ADAS/AD feature in a set of ADAS/AD features (e.g., ADAS/AD features that may use map data) may indicate to an aggregation module of the UE 902 (e.g., a map and V2X data aggregation module) an amount of map data it specified (e.g., to be functional or to achieve a defined quality/functioning threshold). Based on the map data specified by set of ADAS/AD features and also based on aggregating information from available (e.g., stored) map data, sensor information (including camera information), and/or V2X communication(s), the aggregation module (or the UE 902) may determine/identify whether the set of ADAS/AD features (or each ADAS/AD feature in the set of ADAS/AD features) is able to meet a defined quality/functioning threshold. The identification of whether the at least one vehicle feature meets a set of thresholds may be performed by, e.g., the map data request component 198, the camera 1232, the ECU 1234, the one or more sensors 1218, the transceiver(s) 1222, the cellular baseband processor(s) 1224, and/or the application processor(s) 1206 of the apparatus 1204 in FIG. 12.

At 1010, the UE may transmit, to a server based on an identification of whether the at least one vehicle feature meets the set of thresholds, a request for map data, such as described in connection with FIG. 9. For example, at 918, based on the change map data request from the aggregation module (e.g., with an indication of specifying additional/reduced map data), the map provisioning module (or the UE 902) may transmit, to a server 904 (e.g., a map provider, a network entity, etc.), a request for an adjusted/adjustable set of map data. The transmission of the request may be performed by, e.g., the map data request component 198, the ECU 1234, the transceiver(s) 1222, the cellular baseband processor(s) 1224, and/or the application processor(s) 1206 of the apparatus 1204 in FIG. 12.

At 1012, the UE may receive, from the server based on the request, the requested map data, such as described in connection with FIG. 9. For example, at 922, the UE 902 may receive, from the server 904, the requested map data (e.g., the adjusted/adjustable set of map data). The reception of the requested map data may be performed by, e.g., the map data request component 198, the ECU 1234, the transceiver(s) 1222, the cellular baseband processor(s) 1224, and/or the application processor(s) 1206 of the apparatus 1204 in FIG. 12.

In one example, the UE may obtain the sensor information from at least one sensor, where the identification of whether the at least one vehicle feature meets the set of thresholds is based on the obtained sensor information, such as described in connection with FIG. 9. For example, at 910, the UE 902 may obtain the sensor information from at least one sensor, such as described in connection with FIG. 4. The at least one sensor may include a camera, a radio frequency (RF) radar, a light detection and ranging (lidar) sensor), an ultrasonic sensor, or a combination thereof. The obtainment of the sensor information may be performed by, e.g., the map data request component 198, the camera 1232, the ECU 1234, the one or more sensors 1218, the transceiver(s) 1222, the cellular baseband processor(s) 1224, and/or the application processor(s) 1206 of the apparatus 1204 in FIG. 12. In some implementation, the at least one sensor includes at least one of: a camera, a radio frequency (RF) radar, a light detection and ranging (lidar) sensor), an ultrasonic sensor, or a combination thereof.

In another example, the UE may communicate with at least one second UE or an infrastructure via a V2X communication, and receive the V2X information based on the V2X communication, where the identification of whether the at least one vehicle feature meets the set of thresholds is based on the received V2X information, such as described in connection with FIG. 9. For example, at 916, if at least one ADAS/AD feature is unable to function properly without the traffic sign and traffic light status information, the aggregation module (or the UE 902) may attempt to communicate with other vehicles and/or infrastructures in proximity to the UE 902 (e.g., via a V2X communication module) to obtain this information. The communication with at least one second UE may be performed by, e.g., the map data request component 198, the ECU 1234, the transceiver(s) 1222, the cellular baseband processor(s) 1224, and/or the application processor(s) 1206 of the apparatus 1204 in FIG. 12.

In another example, the UE may aggregate one or more of the stored map data, the sensor information, or the V2X information, where the identification of whether the at least one vehicle feature meets the set of thresholds is based on the aggregated one or more of the stored map data, the sensor information, or the V2X information, such as described in connection with FIG. 9. For example, at 910, based on the map data specified by set of ADAS/AD features and also based on aggregating information from available (e.g., stored) map data, sensor information (including camera information), and/or V2X communication(s), the aggregation module (or the UE 902) may determine/identify whether the set of ADAS/AD features (or each ADAS/AD feature in the set of ADAS/AD features) is able to meet a defined quality/functioning threshold. The identification of whether the at least one vehicle feature meets a set of thresholds may be performed by, e.g., the map data request component 198, the camera 1232, the ECU 1234, the one or more sensors 1218, the transceiver(s) 1222, the cellular baseband processor(s) 1224, and/or the application processor(s) 1206 of the apparatus 1204 in FIG. 12.

In another example, the at least one vehicle feature does not meet the set of thresholds based on at least one of the stored map data, the sensor information, or the V2X, where the request is for additional map data, and where the received map data is the additional map data. In some implementations, the UE may further enable the at least one vehicle feature based on the additional map data.

In another example, the at least one vehicle feature meets the set of thresholds based on at least one of the stored map data, the sensor information, or the V2X, where the request is for reduced map data, and where the received map data is the reduced map data. In some implementations, the UE may further determine whether the at least one vehicle feature is capable of meeting the set of thresholds for a defined period without downloading more map data, where a transmission of the request for the reduced map data is further based on a determination that the at least one vehicle feature is capable of meeting the set of thresholds for the defined period without downloading more map data.

In another example, to transmit the request for the map data, the UE may be configured to determine an amount of map data specified for the at least one vehicle feature to meet the set of thresholds, and transmit, to the server, an indication of the amount of map data specified for the at least one vehicle feature to meet the set of thresholds, where a reception of the requested map data is based on the indication.

In another example, the at least one vehicle feature corresponds to at least one ADAS feature, at least one AD feature, or a combination thereof.

In another example, the set of thresholds corresponds to a set of minimum conditions for the at least one feature to function or to prevent the at least one feature to work in a degraded mode.

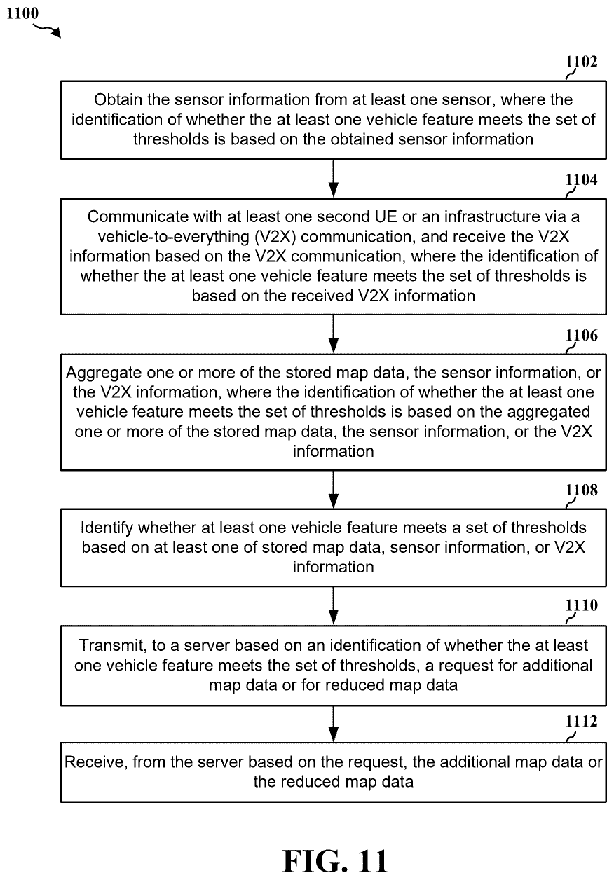

FIG. 11 is a flowchart 1100 of a method of wireless communication at a user equipment (UE). The method may be performed by a UE (e.g., the UE 104, 402, 502, 802, 902; the vehicle 602, 702; the apparatus 1204). The method may enable the UE to dynamically adjust map data to be downloaded from a server based on currently available information and the specifications/demands of ADAS/AD features, thereby reducing/optimizing the overall map data transferred over-the-air.

At 1108, the UE may identify whether at least one vehicle feature meets a set of thresholds based on at least one of stored map data, sensor information, or V2X information, such as described in connection with FIG. 9. For example, at 910, each ADAS/AD feature in a set of ADAS/AD features (e.g., ADAS/AD features that may use map data) may indicate to an aggregation module of the UE 902 (e.g., a map and V2X data aggregation module) an amount of map data it specified (e.g., to be functional or to achieve a defined quality/functioning threshold). Based on the map data specified by set of ADAS/AD features and also based on aggregating information from available (e.g., stored) map data, sensor information (including camera information), and/or V2X communication(s), the aggregation module (or the UE 902) may determine/identify whether the set of ADAS/AD features (or each ADAS/AD feature in the set of ADAS/AD features) is able to meet a defined quality/functioning threshold. The identification of whether the at least one vehicle feature meets a set of thresholds may be performed by, e.g., the map data request component 198, the camera 1232, the ECU 1234, the one or more sensors 1218, the transceiver(s) 1222, the cellular baseband processor(s) 1224, and/or the application processor(s) 1206 of the apparatus 1204 in FIG. 12.

At 1110, the UE may transmit, to a server based on an identification of whether the at least one vehicle feature meets the set of thresholds, a request for map data, such as described in connection with FIG. 9. For example, at 918, based on the change map data request from the aggregation module (e.g., with an indication of specifying additional/reduced map data), the map provisioning module (or the UE 902) may transmit, to a server 904 (e.g., a map provider, a network entity, etc.), a request for an adjusted/adjustable set of map data. The transmission of whether the request may be performed by, e.g., the map data request component 198, the ECU 1234, the transceiver(s) 1222, the cellular baseband processor(s) 1224, and/or the application processor(s) 1206 of the apparatus 1204 in FIG. 12.

At 1112, the UE may receive, from the server based on the request, the requested map data, such as described in connection with FIG. 9. For example, at 922, the UE 902 may receive, from the server 904, the requested map data (e.g., the adjusted/adjustable set of map data). The reception of the requested map data may be performed by, e.g., the map data request component 198, the ECU 1234, the transceiver(s) 1222, the cellular baseband processor(s) 1224, and/or the application processor(s) 1206 of the apparatus 1204 in FIG. 12.

In one example, as shown at 1102, the UE may obtain the sensor information from at least one sensor, where the identification of whether the at least one vehicle feature meets the set of thresholds is based on the obtained sensor information, such as described in connection with FIG. 9. For example, at 910, the UE 902 may obtain the sensor information from at least one sensor, such as described in connection with FIG. 4. The at least one sensor may include a camera, a radio frequency (RF) radar, a light detection and ranging (lidar) sensor), an ultrasonic sensor, or a combination thereof. The obtainment of the sensor information may be performed by, e.g., the map data request component 198, the camera 1232, the ECU 1234, the one or more sensors 1218, the transceiver(s) 1222, the cellular baseband processor(s) 1224, and/or the application processor(s) 1206 of the apparatus 1204 in FIG. 12. In some implementation, the at least one sensor includes at least one of: a camera, a radio frequency (RF) radar, a light detection and ranging (lidar) sensor), an ultrasonic sensor, or a combination thereof.

In another example, as shown at 1104, the UE may communicate with at least one second UE or an infrastructure via a V2X communication, and receive the V2X information based on the V2X communication, where the identification of whether the at least one vehicle feature meets the set of thresholds is based on the received V2X information, such as described in connection with FIG. 9. For example, at 916, if at least one ADAS/AD feature is unable to function properly without the traffic sign and traffic light status information, the aggregation module (or the UE 902) may attempt to communicate with other vehicles and/or infrastructures in proximity to the UE 902 (e.g., via a V2X communication module) to obtain this information. The communication with at least one second UE may be performed by, e.g., the map data request component 198, the ECU 1234, the transceiver(s) 1222, the cellular baseband processor(s) 1224, and/or the application processor(s) 1206 of the apparatus 1204 in FIG. 12.

In another example, as shown at 1106, the UE may aggregate one or more of the stored map data, the sensor information, or the V2X information, where the identification of whether the at least one vehicle feature meets the set of thresholds is based on the aggregated one or more of the stored map data, the sensor information, or the V2X information, such as described in connection with FIG. 9. For example, at 910, based on the map data specified by set of ADAS/AD features and also based on aggregating information from available (e.g., stored) map data, sensor information (including camera information), and/or V2X communication(s), the aggregation module (or the UE 902) may determine/identify whether the set of ADAS/AD features (or each ADAS/AD feature in the set of ADAS/AD features) is able to meet a defined quality/functioning threshold. The identification of whether the at least one vehicle feature meets a set of thresholds may be performed by, e.g., the map data request component 198, the camera 1232, the ECU 1234, the one or more sensors 1218, the transceiver(s) 1222, the cellular baseband processor(s) 1224, and/or the application processor(s) 1206 of the apparatus 1204 in FIG. 12.

In another example, the at least one vehicle feature does not meet the set of thresholds based on at least one of the stored map data, the sensor information, or the V2X, where the request is for additional map data, and where the received map data is the additional map data. In some implementations, the UE may further enable the at least one vehicle feature based on the additional map data.

In another example, the at least one vehicle feature meets the set of thresholds based on at least one of the stored map data, the sensor information, or the V2X, where the request is for reduced map data, and where the received map data is the reduced map data. In some implementations, the UE may further determine whether the at least one vehicle feature is capable of meeting the set of thresholds for a defined period without downloading more map data, where a transmission of the request for the reduced map data is further based on a determination that the at least one vehicle feature is capable of meeting the set of thresholds for the defined period without downloading more map data.

In another example, to transmit the request for the map data, the UE may be configured to determine an amount of map data specified for the at least one vehicle feature to meet the set of thresholds, and transmit, to the server, an indication of the amount of map data specified for the at least one vehicle feature to meet the set of thresholds, where a reception of the requested map data is based on the indication.

In another example, the at least one vehicle feature corresponds to at least one ADAS feature, at least one AD feature, or a combination thereof.

In another example, the set of thresholds corresponds to a set of minimum conditions for the at least one feature to function or to prevent the at least one feature to work in a degraded mode.

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include at least one cellular baseband processor 1224 (also referred to as a modem) coupled to one or more transceivers 1222 (e.g., cellular RF transceiver). The cellular baseband processor(s) 1224 may include at least one on-chip memory 1224′. In some aspects, the apparatus 1204 may further include one or more subscriber identity modules (SIM) cards 1220 and at least one application processor 1206 coupled to a secure digital (SD) card 1208 and a screen 1210. The application processor(s) 1206 may include on-chip memory 1206′. In some aspects, the apparatus 1204 may further include a Bluetooth module 1212, a WLAN module 1214, an ultrawide band (UWB) module 1238, an SPS module 1216 (e.g., GNSS module), one or more sensors 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, a camera 1232, and/or an electronic control unit (ECU) 1234. The Bluetooth module 1212, the UWB module 1238, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor(s) 1224 communicates through the transceiver(s) 1222 via one or more antennas 1280 with the UE 104 and/or with an RU associated with a network entity 1202. The cellular baseband processor(s) 1224 and the application processor(s) 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor(s) 1224 and the application processor(s) 1206 are each responsible for general processing, including the execution of software stored on the computer-readable medium/memory. The software, when executed by the cellular baseband processor(s) 1224/application processor(s) 1206, causes the cellular baseband processor(s) 1224/application processor(s) 1206 to perform the various functions described supra. The cellular baseband processor(s) 1224 and the application processor(s) 1206 are configured to perform the various functions described supra based at least in part of the information stored in the memory. That is, the cellular baseband processor(s) 1224 and the application processor(s) 1206 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1224/application processor(s) 1206 when executing software. The cellular baseband processor(s) 1224/application processor(s) 1206 may be a component of the UE 350 and may include the at least one memory 360 and/or at least one of the TX processor 368, the RX processor 356, and the controller/processor 359. In one configuration, the apparatus 1204 may be at least one processor chip (modem and/or application) and include just the cellular baseband processor(s) 1224 and/or the application processor(s) 1206, and in another configuration, the apparatus 1204 may be the entire UE (e.g., see UE 350 of FIG. 3) and include the additional modules of the apparatus 1204.

As discussed supra, the map data request component 198 may be configured to identify whether at least one vehicle feature meets a set of thresholds based on at least one of stored map data, sensor information, or V2X information. The map data request component 198 may also be configured to transmit, to a server based on an identification of whether the at least one vehicle feature meets the set of thresholds, a request for map data. The map data request component 198 may also be configured to receive, from the server based on the request, the requested map data. The map data request component 198 may be within the cellular baseband processor(s) 1224, the application processor(s) 1206, or both the cellular baseband processor(s) 1224 and the application processor(s) 1206. The map data request component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) 1224 and/or the application processor(s) 1206, may include means for identifying whether at least one vehicle feature meets a set of thresholds based on at least one of stored map data, sensor information, or V2X information. The apparatus 1204 may further include means for transmitting, to a server based on an identification of whether the at least one vehicle feature meets the set of thresholds, a request for map data. The apparatus 1204 may further include means for receiving, from the server based on the request, the requested map data.

In one configuration, the apparatus 1204 may further include means for obtaining the sensor information from at least one sensor, where the identification of whether the at least one vehicle feature meets the set of thresholds is based on the obtained sensor information. In some implementation, the at least one sensor includes at least one of: a camera, an RF radar, a lidar sensor, an ultrasonic sensor, or a combination thereof.

In another configuration, the apparatus 1204 may further include means for communicating with at least one second UE or an infrastructure via a V2X communication, and means for receiving the V2X information based on the V2X communication, where the identification of whether the at least one vehicle feature meets the set of thresholds is based on the received V2X information.

In another configuration, the apparatus 1204 may further include means for aggregating one or more of the stored map data, the sensor information, or the V2X information, where the identification of whether the at least one vehicle feature meets the set of thresholds is based on the aggregated one or more of the stored map data, the sensor information, or the V2X information.

In another configuration, the at least one vehicle feature does not meet the set of thresholds based on at least one of the stored map data, the sensor information, or the V2X, where the request is for additional map data, and where the received map data is the additional map data. In some implementations, the apparatus 1204 may further include means for enabling the at least one vehicle feature based on the additional map data.

In another configuration, the at least one vehicle feature meets the set of thresholds based on at least one of the stored map data, the sensor information, or the V2X, where the request is for reduced map data, and where the received map data is the reduced map data. In some implementations, the apparatus 1204 may further include means for determining whether the at least one vehicle feature is capable of meeting the set of thresholds for a defined period without downloading more map data, where a transmission of the request for the reduced map data is further based on a determination that the at least one vehicle feature is capable of meeting the set of thresholds for the defined period without downloading more map data.

In another configuration, the means for transmitting the request for the map data may include configuring the apparatus 1204 to determine an amount of map data specified for the at least one vehicle feature to meet the set of thresholds, and transmit, to the server, an indication of the amount of map data specified for the at least one vehicle feature to meet the set of thresholds, where a reception of the requested map data is based on the indication.

In another configuration, the at least one vehicle feature corresponds to at least one ADAS feature, at least one AD feature, or a combination thereof.

In another configuration, the set of thresholds corresponds to a set of minimum conditions for the at least one feature to function or to prevent the at least one feature to work in a degraded mode.

The means may be the map data request component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

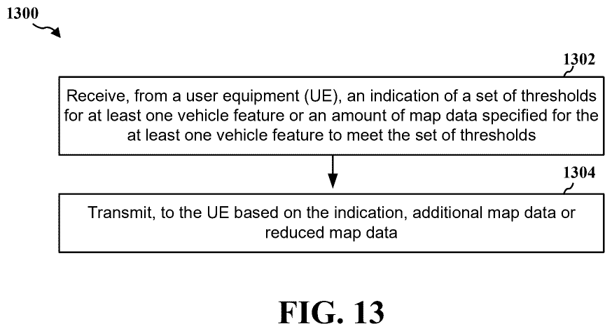

FIG. 13 is a flowchart 1300 of a method of wireless communication. The method may be performed by a network entity (e.g., the one or more location servers 168; the server 504, 804, 904; network entity 1460). The method may enable the network entity to dynamically adjust map data to be provided to a UE based on the specifications/demands of ADAS/AD features at the UE, thereby reducing/optimizing the overall map data transferred over-the-air.

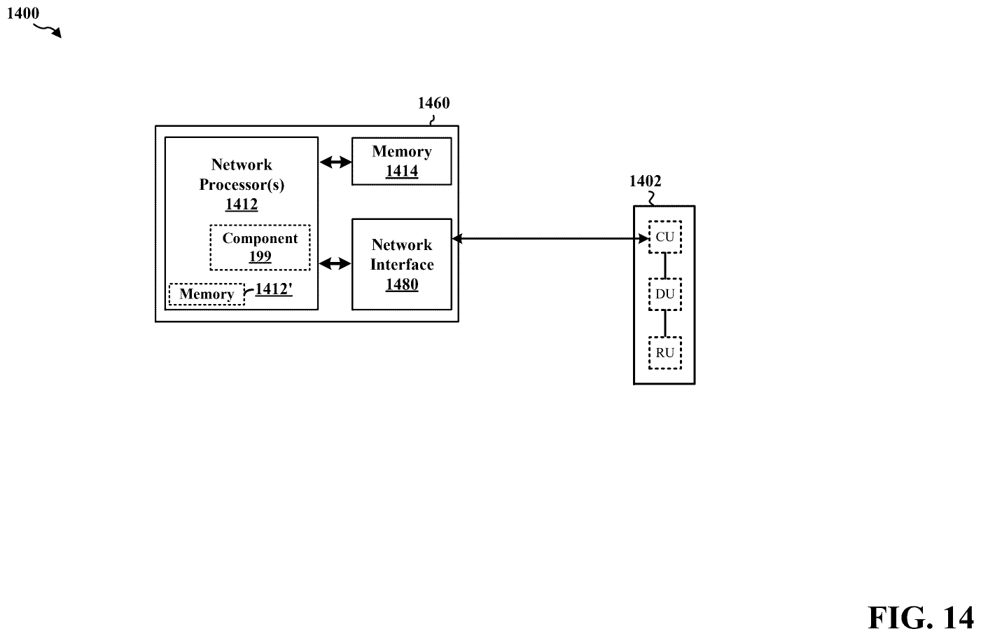

At 1302, the network entity may receive, from a UE, an indication of a set of thresholds for at least one vehicle feature or an amount of map data specified for the at least one vehicle feature to meet the set of thresholds, such as described in connection with FIG. 9. For example, the server may receive, from the UE 902, an indication of map data specified by the set of ADAS/AD features at the UE 902 and/or a set of thresholds to be met by the set of ADAS/AD features, and the server 904 may determine whether current map data at the UE 902 (and/or previous map data transmitted to the UE 902) is sufficient for the set of ADAS/AD features to meet the set of thresholds. The reception of the indication may be performed by, e.g., the map data configuration component 199, the network processor(s) 1412, and/or the network interface 1480 of the network entity 1460 in FIG. 14.

At 1304, the network entity may transmit, to the UE based on the indication, additional map data or reduced map data, such as described in connection with FIG. 9. For example, the server 904 may transmit additional map data to the UE 902 if the current map data at the UE 902 is insufficient for the set of ADAS/AD features to meet the set of thresholds, or transmit reduced map data if the current map data at the UE 902 is sufficient for the set of ADAS/AD features to meet the set of thresholds (e.g., for a defined period). The transmission of the additional map data or the reduced map data may be performed by, e.g., the map data configuration component 199, the network processor(s) 1412, and/or the network interface 1480 of the network entity 1460 in FIG. 14.

In one example the network entity may determine whether current map data at the UE is sufficient for the at least one feature to meet the set of thresholds. In some implementations, to transmit the additional map data or the reduced map data, the network entity may be configured to transmit, to the UE, the additional map data if the current map data at the UE is insufficient for the at least one feature to meet the set of thresholds, or transmit, to the UE, the reduced map data if the current map data at the UE is sufficient for the at least one feature to meet the set of thresholds for a defined period.

In another example, the at least one vehicle feature corresponds to at least one ADAS feature, at least one AD feature, or a combination thereof.

In another example, the set of thresholds corresponds to a set of minimum conditions for the at least one feature to function or to prevent the at least one feature to work in a degraded mode.

FIG. 14 is a diagram 1400 illustrating an example of a hardware implementation for a network entity 1460. In one example, the network entity 1460 may be within the core network 120. The network entity 1460 may include at least one network processor 1412. The network processor(s) 1412 may include on-chip memory 1412′. In some aspects, the network entity 1460 may further include additional memory modules 1414. The network entity 1460 communicates via the network interface 1480 directly (e.g., backhaul link) or indirectly (e.g., through a RIC) with the CU 1402. The on-chip memory 1412′ and the additional memory modules 1414 may each be considered a computer-readable medium/memory. Each computer-readable medium/memory may be non-transitory. The network processor(s) 1412 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the map data configuration component 199 may be configured to receive, from a UE, an indication of a set of thresholds for at least one vehicle feature or an amount of map data specified for the at least one vehicle feature to meet the set of thresholds. The map data configuration component 199 may also be configured to transmit, to the UE based on the indication, additional map data or reduced map data. The map data configuration component 199 may be within the network processor(s) 1412. The map data configuration component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1460 may include a variety of components configured for various functions. In one configuration, the network entity 1460 may include means for receiving, from a UE, an indication of a set of thresholds for at least one vehicle feature or an amount of map data specified for the at least one vehicle feature to meet the set of thresholds. The network entity 1460 may further include means for transmitting, to the UE based on the indication, additional map data or reduced map data.

In one configuration the network entity 1460 may further include means for determining whether current map data at the UE is sufficient for the at least one feature to meet the set of thresholds. In some implementations, the means for transmit the additional map data or the reduced map data may include configuring the network entity 1460 to transmit, to the UE, the additional map data if the current map data at the UE is insufficient for the at least one feature to meet the set of thresholds, or transmit, to the UE, the reduced map data if the current map data at the UE is sufficient for the at least one feature to meet the set of thresholds for a defined period.

In another configuration, the at least one vehicle feature corresponds to at least one ADAS feature, at least one AD feature, or a combination thereof.

In another configuration, the set of thresholds corresponds to a set of minimum condition for the at least one feature to function or to prevent the at least one feature to work in a degraded mode.

The means may be the map data configuration component 199 of the network entity 1460 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: identifying whether at least one vehicle feature meets a set of thresholds based on at least one of stored map data, sensor information, or vehicle-to-everything (V2X) information; transmitting, to a server based on an identification of whether the at least one vehicle feature meets the set of thresholds, a request for map data; and receiving, from the server based on the request, the requested map data.

Aspect 2 is the method of aspect 1, wherein the at least one vehicle feature does not meet the set of thresholds based on at least one of the stored map data, the sensor information, or the V2X, wherein the request is for additional map data, and wherein the received map data is the additional map data.

Aspect 3 is the method of aspect 1 or aspect 2, further comprising: enabling the at least one vehicle feature based on the additional map data.

Aspect 4 is the method of any of aspects 1 to 3, wherein the at least one vehicle feature meets the set of thresholds based on at least one of the stored map data, the sensor information, or the V2X, wherein the request is for reduced map data, and wherein the received map data is the reduced map data.

Aspect 5 is the method of any of aspects 1 to 4, further comprising: determining whether the at least one vehicle feature is capable of meeting the set of thresholds for a defined period without downloading more map data, wherein a transmission of the request for the reduced map data is further based on a determination that the at least one vehicle feature is capable of meeting the set of thresholds for the defined period without downloading more map data.

Aspect 6 is the method of any of aspects 1 to 5, wherein transmitting the map data comprises: determining an amount of map data specified for the at least one vehicle feature to meet the set of thresholds; and transmitting, to the server, an indication of the amount of map data specified for the at least one vehicle feature to meet the set of thresholds, wherein a reception of the requested map data is based on the indication.

Aspect 7 is the method of any of aspects 1 to 6, further comprising: obtaining the sensor information from at least one sensor, wherein the identification of whether the at least one vehicle feature meets the set of thresholds is based on the obtained sensor information.

Aspect 8 is the method of any of aspects 1 to 7, wherein the at least one sensor includes at least one of: a camera, a radio frequency (RF) radar, a light detection and ranging (lidar) sensor), an ultrasonic sensor, or a combination thereof.

Aspect 9 is the method of any of aspects 1 to 8, further comprising: communicating with at least one second UE or an infrastructure via a V2X communication; and receiving the V2X information based on the V2X communication, wherein the identification of whether the at least one vehicle feature meets the set of thresholds is based on the received V2X information.

Aspect 10 is the method of any of aspects 1 to 9, further comprising: aggregating one or more of the stored map data, the sensor information, or the V2X information, wherein the identification of whether the at least one vehicle feature meets the set of thresholds is based on the aggregated one or more of the stored map data, the sensor information, or the V2X information.

Aspect 11 is the method of any of aspects 1 to 10, wherein the at least one vehicle feature corresponds to at least one advanced driver assistance systems (ADAS) feature, at least one autonomous driving (AD) feature, or a combination thereof.

Aspect 12 is the method of any of aspects 1 to 11, wherein the set of thresholds corresponds to a set of minimum conditions for the at least one feature to function or to prevent the at least one feature to work in a degraded mode.

Aspect 13 is an apparatus for wireless communication at a user equipment (UE), including: at least one memory; and at least one processor coupled to the at least one memory and, based at least in part on information stored in the at least one memory, the at least one processor, individually or in any combination, is configured to implement any of aspects 1 to 12.

Aspect 14 is the apparatus of aspect 13, further including at least one transceiver coupled to the at least one processor.

Aspect 15 is an apparatus for wireless communication at a user equipment (UE), including means for implementing any of aspects 1 to 12.

Aspect 16 is a computer-readable medium (e.g., a non-transitory computer-readable medium) storing computer executable code, where the code when executed by a processor causes the processor to implement any of aspects 1 to 12.

Aspect 17 is a method of wireless communication at a server, comprising: receiving, from a user equipment (UE), an indication of a set of thresholds for at least one vehicle feature or an amount of map data specified for the at least one vehicle feature to meet the set of thresholds; and transmitting, to the UE based on the indication, additional map data or reduced map data.

Aspect 18 is the method of aspect 17, further comprising: determining whether current map data at the UE is sufficient for the at least one feature to meet the set of thresholds.

Aspect 19 is the method of aspect 17 or aspect 18, wherein transmitting the additional map data or the reduced map data comprises: transmitting, to the UE, the additional map data if the current map data at the UE is insufficient for the at least one feature to meet the set of thresholds; or transmitting, to the UE, the reduced map data if the current map data at the UE is sufficient for the at least one feature to meet the set of thresholds for a defined period.

Aspect 20 is the method of any of aspects 17 to 19, wherein the at least one vehicle feature corresponds to at least one advanced driver assistance systems (ADAS) feature, at least one autonomous driving (AD) feature, or a combination thereof.

Aspect 21 is the method of any of aspects 17 to 20, wherein the set of thresholds corresponds to a set of minimum conditions for the at least one feature to function or to prevent the at least one feature to work in a degraded mode.

Aspect 22 is an apparatus for wireless communication at a server, including: at least one memory; and at least one processor coupled to the at least one memory and, based at least in part on information stored in the at least one memory, the at least one processor, individually or in any combination, is configured to implement any of aspects 17 to 21.

Aspect 23 is the apparatus of aspect 22, further including at least one network interface coupled to the at least one processor.

Aspect 24 is an apparatus for wireless communication at a server, including means for implementing any of aspects 17 to 21.

Aspect 25 is a computer-readable medium (e.g., a non-transitory computer-readable medium) storing computer executable code, where the code when executed by a processor causes the processor to implement any of aspects 17 to 21.

What is claimed is:

1. An apparatus for wireless communication at a user equipment (UE), comprising:
at least one memory;
at least one transceiver; and
at least one processor coupled to the at least one memory and the at least one transceiver, the at least one processor, individually or in any combination, is configured to:
identify whether at least one vehicle feature meets a set of thresholds based on at least one of stored map data, sensor information, or vehicle-to-everything (V2X) information;
transmit, to a server via the at least one transceiver and based on an identification of whether the at least one vehicle feature meets the set of thresholds, a request for map data; and
receive, from the server via the at least one transceiver and based on the request, the requested map data.

2. The apparatus of claim 1, wherein the at least one vehicle feature does not meet the set of thresholds based on at least one of the stored map data, the sensor information, or the V2X, wherein the request is for additional map data, and wherein the received map data is the additional map data.

3. The apparatus of claim 2, wherein the at least one processor, individually or in any combination, is further configured to:
enable the at least one vehicle feature based on the additional map data.

4. The apparatus of claim 1, wherein the at least one vehicle feature meets the set of thresholds based on at least one of the stored map data, the sensor information, or the V2X, wherein the request is for reduced map data, and wherein the received map data is the reduced map data.

5. The apparatus of claim 4, wherein the at least one processor, individually or in any combination, is further configured to:
determine whether the at least one vehicle feature is capable of meeting the set of thresholds for a defined period without downloading more map data, wherein a transmission of the request for the reduced map data is further based on a determination that the at least one vehicle feature is capable of meeting the set of thresholds for the defined period without downloading more map data.

6. The apparatus of claim 1, wherein to transmit the request for the map data, the at least one processor, individually or in any combination, is configured to:
determine an amount of map data specified for the at least one vehicle feature to meet the set of thresholds; and
transmit, to the server, an indication of the amount of map data specified for the at least one vehicle feature to meet the set of thresholds, wherein a reception of the requested map data is based on the indication.

7. The apparatus of claim 1, wherein the at least one processor, individually or in any combination, is further configured to:
obtain the sensor information from at least one sensor, wherein the identification of whether the at least one vehicle feature meets the set of thresholds is based on the obtained sensor information.

8. The apparatus of claim 7, wherein the at least one sensor includes at least one of: a camera, a radio frequency (RF) radar, a light detection and ranging (lidar) sensor), an ultrasonic sensor, or a combination thereof.

9. The apparatus of claim 1, wherein the at least one processor, individually or in any combination, is further configured to:
communicate with at least one second UE or an infrastructure via a V2X communication; and
receive the V2X information based on the V2X communication, wherein the identification of whether the at least one vehicle feature meets the set of thresholds is based on the received V2X information.

10. The apparatus of claim 1, wherein the at least one processor, individually or in any combination, is further configured to:
aggregate one or more of the stored map data, the sensor information, or the V2X information, wherein the identification of whether the at least one vehicle feature meets the set of thresholds is based on the aggregated one or more of the stored map data, the sensor information, or the V2X information.

11. The apparatus of claim 1, wherein the at least one vehicle feature corresponds to at least one advanced driver assistance systems (ADAS) feature, at least one autonomous driving (AD) feature, or a combination thereof.

12. The apparatus of claim 1, wherein the set of thresholds corresponds to a set of minimum conditions for the at least one feature to function or to prevent the at least one feature to work in a degraded mode.

13. A method of wireless communication at a user equipment (UE), comprising:
identifying whether at least one vehicle feature meets a set of thresholds based on at least one of stored map data, sensor information, or vehicle-to-everything (V2X) information;
transmitting, to a server based on an identification of whether the at least one vehicle feature meets the set of thresholds, a request for map data; and
receiving, from the server based on the request, the requested map data.

14. The method of claim 13, wherein the at least one vehicle feature does not meet the set of thresholds based on at least one of the stored map data, the sensor information, or the V2X, wherein the request is for additional map data, and wherein the received map data is the additional map data.

15. The method of claim 14, further comprising:
enabling the at least one vehicle feature based on the additional map data.

16. The method of claim 13, wherein the at least one vehicle feature meets the set of thresholds based on at least one of the stored map data, the sensor information, or the V2X, wherein the request is for reduced map data, and wherein the received map data is the reduced map data.

17. The method of claim 16, further comprising:
determining whether the at least one vehicle feature is capable of meeting the set of thresholds for a defined period without downloading more map data, wherein a transmission of the request for the reduced map data is further based on a determination that the at least one vehicle feature is capable of meeting the set of thresholds for the defined period without downloading more map data.

18. The method of claim 13, wherein transmitting the request for the map data comprises:
determining an amount of map data specified for the at least one vehicle feature to meet the set of thresholds; and
transmitting, to the server, an indication of the amount of map data specified for the at least one vehicle feature to meet the set of thresholds, wherein a reception of the requested map data is based on the indication.

19. The method of claim 13, further comprising:
obtaining the sensor information from at least one sensor, wherein the identification of whether the at least one vehicle feature meets the set of thresholds is based on the obtained sensor information.

20. The method of claim 19, wherein the at least one sensor includes at least one of: a camera, a radio frequency (RF) radar, a light detection and ranging (lidar) sensor), an ultrasonic sensor, or a combination thereof.

21. The method of claim 13, further comprising:
communicating with at least one second UE or an infrastructure via a V2X communication; and
receiving the V2X information based on the V2X communication, wherein the identification of whether the at least one vehicle feature meets the set of thresholds is based on the received V2X information.

22. The method of claim 13, further comprising:
aggregating one or more of the stored map data, the sensor information, or the V2X information, wherein the identification of whether the at least one vehicle feature meets the set of thresholds is based on the aggregated one or more of the stored map data, the sensor information, or the V2X information.

23. The method of claim 13, wherein the at least one vehicle feature corresponds to at least one advanced driver assistance systems (ADAS) feature, at least one autonomous driving (AD) feature, or a combination thereof.

24. The method of claim 13, wherein the set of thresholds corresponds to a set of minimum conditions for the at least one feature to function or to prevent the at least one feature to work in a degraded mode.

25. An apparatus for wireless communication at a server, comprising:
at least one memory;
at least one network interface; and
at least one processor coupled to the at least one memory and the at least one network interface, the at least one processor, individually or in any combination, is configured to:
receive, from a user equipment (UE) via the at least one network interface, an indication of a set of thresholds for at least one vehicle feature or an amount of map data specified for the at least one vehicle feature to meet the set of thresholds; and
transmit, to the UE based on the indication via the at least one network interface, additional map data or reduced map data.

26. The apparatus of claim 25, wherein the at least one processor, individually or in any combination, is further configured to:
determine whether current map data at the UE is sufficient for the at least one feature to meet the set of thresholds.

27. The apparatus of claim 26, wherein to transmit the additional map data or the reduced map data, the at least one processor, individually or in any combination, is configured to:
transmit, to the UE, the additional map data if the current map data at the UE is insufficient for the at least one feature to meet the set of thresholds; or
transmit, to the UE, the reduced map data if the current map data at the UE is sufficient for the at least one feature to meet the set of thresholds for a defined period.

28. The apparatus of claim 25, wherein the at least one vehicle feature corresponds to at least one advanced driver assistance systems (ADAS) feature, at least one autonomous driving (AD) feature, or a combination thereof.

29. The apparatus of claim 25, wherein the set of thresholds corresponds to a set of minimum conditions for the at least one feature to function or to prevent the at least one feature to work in a degraded mode.

30. A method of wireless communication at a server, comprising:
receiving, from a user equipment (UE), an indication of a set of thresholds for at least one vehicle feature or an amount of map data specified for the at least one vehicle feature to meet the set of thresholds; and
transmitting, to the UE based on the indication, additional map data or reduced map data.
